(19) United States
(12) Patent Application Publication
(10) Pub. No.: US 2026/0166526 A1
(43) Pub. Date: Jun. 18, 2026

(54) COMPOSITE CATALYST FOR AMMONIA DECOMPOSITION AND HYDROGEN PRODUCTION AND METHOD FOR PRODUCING THE SAME

(71) Applicant: KOREA INSTITUTE OF ENERGY RESEARCH, Daejeon (KR)

(72) Inventors: Kee Young KOO, Daejeon (KR); Un Ho JUNG, Daejeon (KR); Yong Ha PARK, Cheonan-si (KR); Gi Dong SIM, Gimhae-si (KR); Ye Ji CHOI, Daejeon (KR)

(73) Assignee: KOREA INSTITUTE OF ENERGY RESEARCH, Daejeon (KR)

(21) Appl. No.: 19/382,798

(22) Filed: Nov. 7, 2025

(30) Foreign Application Priority Data
Sep. 25, 2024 (KR) 10-2024-0129930

(51) Int. Cl. B01J 23/78; B01J 23/00; B01J 23/04; B01J 23/10; B01J 35/30; B01J 35/61; B01J 35/63; B01J 37/02; B01J 37/03; B01J 37/04; B01J 37/08; C01B 3/046

(52) U.S. Cl. CPC B01J 23/78; B01J 23/002; B01J 23/04; B01J 23/10; B01J 35/393; B01J 35/394; B01J 35/613; B01J 35/615; B01J 35/633; B01J 35/635; B01J 37/0207; B01J 37/031; B01J 37/04; B01J 37/088; C01B 3/046

(57) ABSTRACT

One embodiment of the present invention provides a metal composite catalyst for ammonia decomposition and hydrogen production, comprising: a composite metal oxide support; and metal nanoparticles dispersed on a surface or inside pores of the composite metal oxide; wherein the composite metal oxide support is derived from a layered double hydroxide comprising nickel and at least two types of metals different from nickel, the metal nanoparticles are reduced from the composite metal oxide support, and a weight content of nickel metal, measured by ICP analysis, is 45 wt % or more.

### BACKGROUND

### 1. Technical Field

The present invention relates to a metal composite catalyst for ammonia decomposition and hydrogen production, and more particularly, utilizing a support based on a layered double hydroxide, to a composite catalyst having high ammonia decomposition efficiency even under relatively low-temperature conditions, a method for producing the same, and a system and a process for ammonia decomposition and hydrogen production utilizing the composite catalyst.

### 2. Related Art

Recently, due to abnormal climate change progressing worldwide, many difficulties are arising across all industries. As the biggest cause of the abnormal climate, global warming due to continuous use of fossil fuels can be cited. Particularly in the case of East Asia, although no significant difference in average temperature change is shown from 1996 to 2005, a rapid rise is observed from the mid-21st century, and for 133 years from 1880 to 2012, the global average temperature is confirmed to have risen by about 0.85° C.

If the global temperature rises by 2° C., about 15 to 40% of living species may become extinct, and to prevent this, various countries around the world are presenting measures such as reducing greenhouse gas emissions by half by 2030, emphasizing the importance of carbon neutral (Carbon neutral), and are step by step implementing a state where the actual emission amount is zero (zero) by minimizing the emission of greenhouse gases and absorbing and using greenhouse gases (IPCC 6th report).

To realize carbon neutral, it is a situation where reducing the use of energy using coal and natural gas and using carbon-free fuel is necessary. For this, alternative energy is necessary, and recently, technology development and commercialization are progressing based on renewable energy. However, in the case of renewable energy, problems may arise in energy supply due to geographical and natural factors.

Recently, as a medium to compensate for such intermittency and variability of renewable energy, hydrogen is drawing attention as an alternative energy capable of storing electric power, which is real-time production and consumption, and many related research and demonstration projects are progressing. When generating power using hydrogen, it is known as eco-friendly power generation that does not emit harmful gases such as carbon dioxide and produces heat and electricity with high energy efficiency. According to the Hydrogen Council, the global hydrogen demand is predicted to increase to about 100 million tons in 2030 and 550 million tons in 2050.

However, since a method of storing and transporting hydrogen as high-pressure gaseous hydrogen is mainly used, there is a disadvantage that there is an explosion risk, the cost is expensive, and there is a limit to the storage amount.

In the case of hydrogen, as the thickness of the insulation material increases, a fuel storage tank corresponding to about 7.6 times that of existing fossil fuels is required. On the other hand, the volumetric hydrogen energy density of ammonia is 121 kg/m³, which is larger than 70.8 kg/m³ of liquefied hydrogen, and accordingly it is being used in various industries. Looking more specifically, when considering the cost of transporting by pipeline, hydrogen is at the 1.87 dollar level, but ammonia is 0.19 dollars, which is about 10% level. In addition, from a storage perspective, when storing for 6 months, the production, transport, and storage cost is 19.82 dollars for hydrogen and 4.53 dollars for ammonia, so it can be seen that hydrogen is about 4.3 times higher.

For transport and storage of hydrogen, a method of storing in the form of ammonia is commonly used, but for ammonia decomposition, because a high temperature and a lot of system energy for this are required, development of a catalyst for ammonia decomposition is a necessary situation.

Ruthenium (Ru) is an active metal widely used in the field of ammonia decomposition ((NH₃→1/2N₂+3/2H₂) and shows high activity in the ammonia decomposition reaction, but is greatly affected by particle shape and size, and because difficulties in application exist in terms of rarity and economic feasibility, development of an active metal catalyst that can replace this is a necessary situation.

Nickel (Ni) has high activity among non-precious metal-based catalysts, and compared to ruthenium, is abundantly distributed on Earth, and is also inexpensive, making it economical. Compared to when using ruthenium, the catalyst can be supplied at a price up to about 70 times lower, but the interaction with ammonia molecules is weak, so the performance is poor, and to activate ammonia molecules, a high temperature of 600 degrees or more is required.

Therefore, for producing a catalyst for ammonia decomposition reaction excellent in low-temperature activity, it is necessary to highly disperse and uniformly support a high content of Ni active metal, or to design the composite catalyst with a structure most suitable for ammonia decomposition efficiency.

Using a conventional support with a large specific surface area, by conventional catalyst loading methods such as ion-exchange method, impregnation method, and precipitation method, there was a difficult aspect in highly dispersing and uniformly supporting a high content of Ni active metal, and there was a problem that high ammonia decomposition efficiency is not secured due to the structure of the composite catalyst.

### SUMMARY

The present invention has been devised to solve the above-mentioned problems, and one embodiment of the present invention provides a metal composite catalyst for ammonia decomposition and hydrogen production.

In addition, another embodiment of the present invention provides the method for producing the metal composite catalyst for ammonia decomposition and hydrogen production.

In addition, another embodiment of the present invention provides a method for ammonia decomposition and hydrogen production utilizing the catalyst.

In addition, another embodiment of the present invention provides a system for ammonia decomposition and hydrogen production.

The technical problems to be solved by the present invention are not limited to the technical problems mentioned above, and other unmentioned technical problems will be clearly understood by a person having ordinary skill in the art to which the present invention pertains from the following description.

As a technical means for achieving the above-mentioned technical problems, one aspect of the present invention provides:

a metal composite catalyst for ammonia decomposition and hydrogen production, comprising: a composite metal oxide support; and metal nanoparticles dispersed on a surface or inside pores of the composite metal oxide; wherein the composite metal oxide support is derived from a layered double hydroxide comprising nickel and at least two types of metals different from nickel, the metal nanoparticles are reduced from the composite metal oxide support, and a weight content of nickel metal, measured by ICP analysis, is 45 wt % or more.

The metal composite catalyst may comprise magnesium as a first metal and aluminum as a second metal, and based on 100 parts by weight of the metal composite catalyst, a content of the first metal may be 5 to 20 parts by weight, and a content of the second metal may be 5 to 30 parts by weight.

The metal composite catalyst may further comprise a third metal introduced by an impregnation method, and the third metal may comprise potassium or cerium.

Based on 100 parts by weight of the metal composite catalyst, a content of the third metal may be 5 to 10 parts by weight.

A metal dispersion (Metal Dispersion) of the metal nanoparticles of the metal composite catalyst for ammonia decomposition and hydrogen production may be 0.5 to 8%.

A dispersed area of the metal nanoparticles of the metal composite catalyst for ammonia decomposition and hydrogen production may be 2 to 35 m²/g_{cat}.

A BET surface area of the metal composite catalyst for ammonia decomposition and hydrogen production may be 40 to 250 m²/g.

A total pore volume of the metal composite catalyst for ammonia decomposition and hydrogen production may be 0.10 to 0.7 cm³/g.

The metal dispersion of the metal nanoparticles per metal particle area (m²) may be 0.35% or less.

The metal may be at least one transition metal nanoparticle selected from the group consisting of magnesium, aluminum, iron, manganese, nickel, cobalt, titanium, and zinc.

Another aspect of the present invention provides a method for producing a metal composite catalyst for ammonia decomposition and hydrogen production, comprising:

a step of preparing a first solution by respectively preparing and mixing a nickel precursor and precursors of at least two types of different metals; a step of preparing a second solution comprising a carbonate precursor; a step of obtaining a first mixture by simultaneously adding a third solution upon mixing the first and second solutions; a step of aging the first mixture; a step of separating a precipitate of the aged first mixture; a step of drying the precipitate to obtain a layered double hydroxide; and a step of heat-treating the layered double hydroxide; wherein a weight content of nickel metal, measured by ICP analysis, is 45 wt % or more.

The method may further comprise: a step of heat-treating the layered double hydroxide; thereafter a step of introducing a third metal by adding a precursor solution of the third metal to the heat-treated layered double hydroxide to impregnate the same; and a step of second heat-treating the layered double hydroxide-based metal oxide support into which the third metal is introduced.

The method may further comprise: a step of heat-treating the layered double hydroxide; thereafter a step of reducing in the presence of a gas comprising an inert gas.

In the step of preparing the first solution; a ratio of the sum of the number of moles of nickel and the number of moles of the at least two types of metals may be 0.3 to 3:1.

In the step of preparing the first mixture; a pH of the first mixture after adding a base may be 8 to 11.

The step of aging the first mixture; may be stirring at a temperature of 40 to 80° C. for 6 to 48 hours.

The step of drying the precipitate to obtain a layered double hydroxide; may be performed at a temperature of 80 to 150° C.

The step of heat-treating the layered double hydroxide or the second heat-treating step; may be performed at 400 to 800° C. for 1 to 6 hours.

The step of reducing in the presence of the gas comprising an inert gas; may be performed at 500 to 800° C.

Another aspect of the present invention provides a method for ammonia decomposition and hydrogen production, comprising:

a step of preparing the metal composite catalyst for ammonia decomposition and hydrogen production according to the method; and a step of generating a separated gas comprising nitrogen and hydrogen by introducing a reaction gas comprising ammonia in the presence of the metal composite catalyst for ammonia decomposition and hydrogen production.

Another aspect of the present invention provides a system for ammonia decomposition and hydrogen production, comprising:

a reactor loaded with the catalyst; a reaction gas inlet provided at one end of the reactor, and into which ammonia is respectively injected; and a separated gas outlet provided at the other end of the reactor, and from which a gas comprising hydrogen and nitrogen separated by the ammonia decomposition reaction is discharged.

According to the embodiment of the present invention, a non-precious metal-based metal composite catalyst having high ammonia decomposition activity at a relatively low-temperature can be provided.

In addition, according to one embodiment of the present invention, a method capable of producing the non-precious metal-based catalyst for ammonia decomposition and hydrogen production through a co-precipitation method, which is a simple bottom-up method, can be provided.

The effects of the present invention are not limited to the effects described above, and it should be understood as including all effects that can be inferred from the configuration of the invention described in the description of the present invention or the claims.

### BRIEF DESCRIPTION OF THE DRAWINGS

FIG. 1 is a schematic diagram briefly showing an experimental apparatus for an ammonia decomposition reaction system according to one embodiment of the present invention.

FIG. 2 is experimental data comparing the ammonia decomposition catalyst activity of the catalyst according to one embodiment of the present invention by temperature.

FIG. 3 is experimental data comparing the ammonia decomposition reaction activity of the catalyst according to the metal composition of the layered double hydroxide-based catalyst according to one embodiment of the present invention.

FIG. 4 is experimental data comparing the reduction temperature (H2-TPR) for each catalyst of Examples and Comparative Examples according to one embodiment of the present invention.

FIG. 5 is experimental data comparing the activity by space velocity of the ammonia decomposition catalyst according to one embodiment of the present invention.

### DETAILED DESCRIPTION

Hereinafter, the present invention will be described in more detail. However, the present invention may be embodied in many different forms, is not limited by the embodiments described herein, and is only defined by the claims that will be described later.

In addition, the terminology used in the present invention is used only to describe specific embodiments and is not intended to limit the present invention. A singular expression includes a plural expression unless the context clearly indicates otherwise. In the entire specification of the present invention, that a certain component ‘comprises’ something means that it may further comprise other components rather than excluding other components, unless there is a specific description to the contrary.

In the entire specification, when a certain part is “connected (connected, contacted, coupled)” to another part, this includes not only a case where it is “directly connected” but also a case where it is “indirectly connected” with another member interposed therebetween. In addition, when a certain part “comprises” a certain component, this means that it may be further provided with other components rather than excluding other components, unless there is a specific description to the contrary.

In the entire specification, in the case of the “%” expression, unless otherwise described, it may mean a weight content, and in a case where a standard is separately described or stated, it may be according to the corresponding statement or description.

In the present specification, the term “calcination (calcination)” may mean being heated to high temperatures in air or oxygen (heating to high temperatures in air or oxygen). In the present invention, it may be heat-treating, that is, calcination treating, to oxidize the catalyst through air at a high temperature.

In the present specification, the terminology used is used only to describe specific embodiments and is not intended to limit the present invention. A singular expression includes a plural expression unless the context clearly indicates otherwise.

A first aspect of the present invention provides: a metal composite catalyst for ammonia decomposition and hydrogen production, comprising:

a composite metal oxide support; and metal nanoparticles dispersed on a surface or inside pores of the composite metal oxide; wherein the composite metal oxide support is derived from a layered double hydroxide comprising nickel and at least two types of metals different from nickel, the metal nanoparticles are reduced from the composite metal oxide support, and a weight content of nickel metal, measured by ICP analysis, is 45 wt % or more.

Hereinafter, the metal composite catalyst for ammonia decomposition and hydrogen production according to the first aspect of the present invention will be described in detail.

In one embodiment of the present invention, the composite metal oxide support may be derived from a layered double hydroxide (layerd double hydroxide, LDH), which is a substance capable of artificial synthesis, is composed of layers of divalent and trivalent cations, and is an ionic clay material in the form of a cube having a two-dimensional nanostructure capable of inserting various anions between the layers. Because it has a structure similar to Hydrotalcite (Mg₆Al₂(OH)₁₆CO₃—4H₂O), a natural mineral, it is also called a hydrotalcite-like compound. The chemical formula of LDH is generally expressed as [M²⁺₁₋ₓM³⁺ₓ(OH)₂]^{x+}[(A^{m-})_{x/m}—nH₂O]^{x-}, and in the chemical formula, the divalent cation M²⁺ may be composed of metals such as magnesium (Mg), zinc (Zn), iron (Fe), titanium (Ti), nickel (Ni), and copper (Cu), and the trivalent cation M³⁺ may be composed of metals such as aluminum (Al), chromium (Cr), and calcium (Ca). A^{m-} inserted between the layers, many organic, inorganic anions such as OH⁻, Cl⁻, NO³⁻, and SO₄²⁻ may be capable of being inserted.

The catalyst according to one embodiment of the present invention may mean a catalyst in which, in the process of producing this layered double hydroxide as a precursor of the support, not just using one metal as a divalent cation, a ternary or quaternary layered double hydroxide is allowed to be formed, and thereafter, a composite metal oxide is first formed through oxidation, and then, by performing a heat-treatment for reduction, a ternary or quaternary composite metal exsolved on the composite metal oxide support derived from the layered double hydroxide is dispersed and distributed, or it may be that an additional metal (third metal) is composited to the composite metal oxide support derived from the layered double hydroxide by an impregnation method. Preferably, in the case of the ternary or quaternary composite metal, it basically comprises nickel, and may comprise magnesium as an additional first metal and aluminum as a second metal, and when composited and comprised by additional impregnation, may comprise cerium or potassium as a third metal.

In one embodiment of the present invention, the production process of the layered double hydroxide may use a co-precipitation method or a hydrothermal synthesis method, and preferably, the co-precipitation method may be utilized.

In one embodiment of the present invention, based on 100 parts by weight of the metal composite catalyst, the content of nickel may be 45 to 80 parts by weight, and if it is less than the above-mentioned range, there is a possibility that the activity temperature of the catalyst is not formed at a desired temperature, or the purpose of the present invention of producing a non-precious metal-based catalyst may not be sufficiently achieved, and if it exceeds the above-mentioned range, an insufficient effect may be exhibited in terms of stability or activity of the catalyst.

In one embodiment of the present invention, the metal composite catalyst comprises magnesium as a first metal and aluminum as a second metal, and based on 100 parts by weight of the metal composite catalyst, a content of the first metal may be 5 to 20 parts by weight, and a content of the second metal may be 5 to 30 parts by weight. If it is less than the above-mentioned range, it may not exhibit activity as composite metal particles, and if it exceeds the above-mentioned range, the catalyst activity of copper metal may be inhibited, and thus may show an adverse effect on the overall activity of the catalyst.

In one embodiment of the present invention, it may additionally comprise potassium or cerium as a third metal, and in the case of this third metal, after impregnating the produced layered double hydroxide-based composite metal oxide support in the precursor solution of the third metal for a predetermined time, preferably, after completely drying at a high temperature of 100° C. or more, an additional heat-treatment (calcination) may be performed to produce the catalyst for ammonia decomposition and hydrogen production. When the catalyst is produced by including the third metal in this way, even under harsh conditions such as higher space velocity conditions, a high ammonia conversion rate may be exhibited.

In one embodiment of the present invention, based on 100 parts by weight of the metal composite catalyst, a content of the third metal may be 5 to 10 parts by weight. If it is less than the above-mentioned range, an improvement effect on the ammonia conversion rate due to the space velocity increase may not be sufficiently exhibited, and if it exceeds the above-mentioned range, it may function as an impurity that inhibits the basic catalyst activity of nickel metal.

In one embodiment of the present invention, the metal dispersion (Metal Dispersion) of the metal nanoparticles of the metal composite catalyst for ammonia decomposition and hydrogen production may mean a degree of dispersion of a total sum of metals of different types from each other, and may be 0.15% or more, 0.25% or more, 0.375% or more, 0.45% or more, 0.5% or more, or 0.6% or more, and may be 20% or less, 16% or less, 12% or less, 12% or less, 10% or less, or 8% or less. If it is less than the above-mentioned range, the active metal may not be uniformly supported, and thus the catalyst activity may be low.

In one embodiment of the present invention, the dispersed area of the metal nanoparticles of the metal composite catalyst for ammonia decomposition and hydrogen production may be 0.6 m²/g_{cat} or more, 1 m²/g_{cat} or more, 1.5 m²/g_{cat} or more, 1.8 m²/g_{cat} or more, 2 m²/g_{cat} or more, or 2.4 m²/g_{cat} or more, and may be 87.5 m²/g_{cat} or less, 70 m²/g_{cat} or less, 52.5 m²/g_{cat} or less, 52.5 m²/g_{cat} or less, 43.75 m²/g_{cat} or less, or 35 m²/g_{cat} or less. If it is less than the range, the dispersed area is too small, so the metal may be aggregated in particle form, and thus the activity of the catalyst may exhibit a locally different aspect.

In one embodiment of the present invention, the metal dispersion of the metal nanoparticles per metal particle area (m²) may be 0.875% or less, 0.7% or less, 0.525% or less, 0.525% or less, 0.4375% or less, or 0.35% or less. As will be described later, when satisfying the range, it can be confirmed that the ammonia decomposition activity is maximized, which means that while a sufficient metal dispersion area is secured, the metal dispersion must also exhibit a level that is not excessively low, and in addition, in the case of the catalyst according to one embodiment of the present invention, because the layered double hydroxide-based composite metal oxide support is used, it may mean a most suitable metal dispersion aspect due to a difference in structure.

In one embodiment of the present invention, the BET surface area of the metal composite catalyst may be 27 m²/g or more, 45 m²/g or more, 67.5 m²/g or more, 81 m²/g or more, 90 m²/g or more, or 108 m²/g or more, and may be 625 m²/g or less, 500 m²/g or less, 375 m²/g or less, 375 m²/g or less, 312.5 m²/g or less, or 250 m²/g or less. If it exceeds the above-mentioned range, unnecessarily the volume of the metal composite catalyst may become large, or, a necessary level of strength may not be secured, and, if it is less than the above-mentioned range, a decrease in ammonia decomposition efficiency may be exhibited.

In one embodiment of the present invention, the catalyst may be one having a porous structure, and specifically may be one simultaneously comprising micro pores and meso pores. The total pore volume of the metal composite catalyst may be one defined as the sum of the micro pore volume and the meso pore volume, and other pore volumes may be additionally comprised. Specifically, the total pore volume of the metal composite catalyst may be 0.03 cm³/g or more, 0.05 cm³/g or more, 0.075 cm³/g or more, 0.09 cm³/g or more, 0.1 cm³/g or more, or 0.12 cm³/g or more, and may be 1.75 cm³/g or less, 1.4 cm³/g or less, 1.05 cm³/g or less, 1.05 cm³/g or less, 0.875 cm³/g or less, or 0.7 cm³/g or less. If it exceeds the above-mentioned range, unnecessarily the volume of the metal composite catalyst may become large, or, a necessary level of strength may not be secured, and, if it is less than the above-mentioned range, a decrease in ammonia decomposition efficiency may be exhibited.

In one embodiment of the present invention, the particle size of the metal nanoparticles dispersed on the surface of the metal composite catalyst may be 10 nm or more, 14 nm or more, 18 nm or more, 22 nm or more, 24 nm or more, or 50 nm or more, and may be 290 nm or less, 200 nm or less, 150 nm or less, 140 nm or less, 135 nm or less, or 131 nm or less. If it exceeds the above-mentioned range, the particle diameter of the metal particles may become excessively large, and, activity of the reaction may not be sufficiently generated, and, uniform dispersion may also become difficult. If it is less than the above-mentioned range, it is difficult to be regarded as uniformly dispersed nanoparticles of which the particle diameter and shape are overall in a controllable range.

In one embodiment of the present invention, the shape of the metal nanoparticles may be at least one selected from the group consisting of spherical, hemispherical, plate-like, cylinder shape, and a polyhedron comprising a flat surface, and, preferably, may be one consisting of hemispherical, a polyhedron comprising a flat surface, and a combination thereof.

In one embodiment of the present invention, the metal composite catalyst may be a product which has undergone a reduction reaction in an environment of hydrogen and/or an inert gas prior to reaction.

In one embodiment of the present invention, the metal composite catalyst for ammonia decomposition and hydrogen production may come to have high ammonia decomposition reaction activity at a relatively low-temperature. Specifically, the catalyst may have an ammonia conversion rate of 80% or more at a 600° C. temperature. This characteristic, as will be demonstrated by an Example to be described later, but, compared to the conventional commercially available catalyst, the same level of ammonia gas conversion can be achieved at a lower temperature.

A second aspect of the present invention provides a method for producing a metal composite catalyst for ammonia decomposition and hydrogen production, comprising: a step of preparing a first solution by respectively preparing and mixing a nickel precursor and precursors of at least two types of different metals; a step of preparing a second solution comprising a carbonate precursor; a step of obtaining a first mixture by simultaneously adding a base solution, which is a third solution, upon mixing the first and second solutions; a step of aging the first mixture; a step of separating a precipitate of the aged first mixture; a step of drying the precipitate to obtain a layered double hydroxide; and a step of heat-treating the layered double hydroxide; wherein a weight content of nickel metal, measured by ICP analysis, is 45 wt % or more.

Regarding parts overlapping with the first aspect of the present invention, a detailed description thereof has been omitted, but, contents described for the first aspect of the present invention may be identically applied even if the description thereof is omitted in the second aspect.

Hereinafter, the method for producing a metal composite catalyst for ammonia decomposition and hydrogen production according to the second aspect of the present invention will be described in detail.

First, in one embodiment of the present invention, it may comprise a step of preparing a first solution by respectively preparing and mixing a nickel precursor and precursors of at least two types of different metals.

In one embodiment of the present invention, the nickel precursor, if it is an ordinary salt comprising nickel, can be used without limitation, but, for example, may be at least one selected from the group consisting of nickel nitrate, nickel acetone salt, nickel acetate, nickel acetoacetonate, nickel sulfate, nickel chloride, nickel halide salt, and a mixture thereof, and, preferably, may be Ni(NO₃)₂·6H₂O. In addition, in one embodiment of the present invention, when comprised, when magnesium is used as an added metal, the precursor of the metal, if it is a salt of magnesium, can be used without limitation, but, preferably, may be Mg(NO₃)₂·6H₂O. In addition, in one embodiment of the present invention, when comprised, when aluminum is used as an added metal, the precursor of the metal, if it is a salt of aluminum, can be used without limitation, but, preferably, may be Al(NO₃)₂·9H₂O.

In one embodiment of the present invention, in the step of preparing the first solution; the ratio of the sum of the number of moles of nickel and the number of moles of the at least two types of metals may be 0.09:1 or more, 0.15:1 or more, 0.225:1 or more, 0.27:1 or more, 0.3:1 or more, or 0.36:1 or more, and may be 7.5:1 or less, 6:1 or less, 4.5:1 or less, 4.5:1 or less, 3.75:1 or less, or 3:1 or less. If it is less than the range, nickel may not be sufficiently comprised, and thus the reaction activity of the produced catalyst may be insufficient, and, if it exceeds the range, it may become difficult to utilize the advantages as a multi-component catalyst.

Specifically, in one embodiment of the present invention, the molar ratio of the nickel to the first metal may be 0.3:1 or more, 0.5:1 or more, 0.75:1 or more, 0.9:1 or more, 1:1 or more, or 1.2:1 or more, and may be 10:1 or less, 8:1 or less, 6:1 or less, 6:1 or less, 5:1 or less, or 4:1 or less.

In addition, in another embodiment of the present invention, when a second metal is additionally comprised, the molar ratio of the nickel to the second metal may be 0.3:1 or more, 0.5:1 or more, 0.75:1 or more, 0.9:1 or more, 1:1 or more, or 1.2:1 or more, and may be 10:1 or less, 8:1 or less, 6:1 or less, 6:1 or less, 5:1 or less, or 4:1 or less. In addition, the molar ratio of the first metal to the second metal may be 0.15:1 or more, 0.25:1 or more, 0.375:1 or more, 0.45:1 or more, 0.5:1 or more, or 0.6:1 or more, and may be 3.75:1 or less, 3:1 or less, 2.25:1 or less, 2.25:1 or less, 1.875:1 or less, or 1.5:1 or less.

By satisfying the molar ratio between the above-mentioned multi-component metals, it becomes possible to realize optimized catalyst properties in terms of reaction activity and ammonia conversion rate.

Next, in one embodiment of the present invention, it may comprise a step of preparing a second solution comprising a carbonate precursor.

In one embodiment of the present invention, the carbonate precursor, if it is a metal salt comprising CO₃²⁻, as a commonly used precursor, can be used without limitation, but, preferably, may be a carbonate of an alkali metal, or a carbonate of a transition metal, and, more preferably, may be Na₂CO₃.

In one embodiment of the present invention, in the case of a solvent used in production of the first or second solution, a polar or non-polar organic, inorganic solvent may be utilized without limitation, but, preferably, may be deionized water, or may be distilled water.

In one embodiment of the present invention, the carbonate precursor may be comprised in an amount less than a weight of the precursor of the second metal, and, preferably, may be comprised as 30 to 60 parts by weight based on 100 parts by weight of the second metal precursor.

Next, in one embodiment of the present invention, it may comprise a step of obtaining a first mixture by simultaneously adding a third solution upon mixing the first and second solutions.

In one embodiment of the present invention, the step of obtaining the first mixture may be a method of slowly adding the first solution and the second solution simultaneously to an empty container, or, may be a method of adding the second or first solution slowly, after adding the first or second solution to a container. At this time, it may be obtaining a first mixture by simultaneously adding a third solution upon mixing the first and second solutions, and, the third solution may be a base solution.

In one embodiment of the present invention, in the step of preparing the first mixture; a pH of the first mixture after adding a base may be 8 to 11. In addition, in one embodiment of the present invention, there is no limitation to a type of the base, but, a base that can control only a pH range to a base range without greatly participating in the reaction may be preferably used, and, more preferably, NaOH may be used.

Next, in one embodiment of the present invention, it may comprise a step of aging the first mixture; a step of separating a precipitate of the aged first mixture.

In one embodiment of the present invention, the step of aging the first mixture may be stirring the mixed solution for a predetermined time under appropriate high-temperature conditions after the addition of the base is completed, and, preferably, the step of aging the first mixture; may be stirring at a temperature of 40 to 80° C. for 6 to 48 hours. In addition, in one embodiment of the present invention, the stirring may be characterized by stirring at a speed of 150 to 500 rpm. Although there is no great limitation on the Impeller shape, preferably, a means capable of stirring at a speed of 200 to 300 rpm may be utilized. Specifically, in one embodiment of the present invention, although the Stirring method is not limited in the mixing process, the mixing method used in the present patent is a method using a magnetic bar, and, although there is no great limitation on the Impeller shape, various mixers such as a propeller (Propeller) type may be used.

In one embodiment of the present invention, the step of separating the precipitate of the aged first mixture may be a separation process utilizing filtration, filtering, etc., and, a non-limiting method may be utilized under conditions that do not adversely affect the properties of the precipitate.

Next, in one embodiment of the present invention, it may comprise a step of drying the precipitate to obtain a layered double hydroxide. The drying temperature may proceed at a temperature of 60 to 150° C., preferably 80 to 150° C. If it exceeds the temperature range, it affects the catalyst pore size and volume due to rapid moisture evaporation. In addition, it is preferable to perform the drying until the solid content is completely dried, and, more preferably, may proceed for 1 to 24 hours.

Next, in one embodiment of the present invention, it may comprise a step of heat-treating the layered double hydroxide. The heat-treatment may be a step of calcination. Through this step, it may mean a process of converting into a composite oxide support of a multi-component metal, by oxidizing the layered double hydroxide, while generally maintaining the shape of the layered double hydroxide.

In one embodiment of the present invention, it is preferable to proceed at the calcination temperature at a temperature of 400 to 800° C. If it is less than the temperature range, a problem may be caused that sufficient oxidation of the layered double hydroxide into an oxide does not occur, and, if it exceeds the temperature range, aggregation may occur of different metal particles on the surface, so, consequently, a problem may arise that catalyst activity is decreased.

In addition, in one embodiment of the present invention, it is preferable for the calcination (the step of heat-treating the layered double hydroxide or the second heat-treating step to be described later) to proceed for 1 to 6 hours. If it exceeds the time range, it may be difficult to maintain appropriate reaction activity due to aggregation of the active metal, or is inefficient from an energy perspective, and, if it is less than the time range, oxidation is not sufficiently achieved, so, a meaning of the calcination process itself will be lost.

In one embodiment of the present invention, it may further comprise: a step of heat-treating the layered double hydroxide; thereafter a step of introducing a third metal by adding a precursor solution of the third metal to the heat-treated layered double hydroxide to impregnate the same; and a step of second heat-treating the layered double hydroxide-based metal oxide support into which the third metal is introduced. This may mean a step of introducing a third metal as an additional active ingredient for improving the low-temperature activity of the ammonia decomposition reaction under more harsh conditions.

In one embodiment of the present invention, for example, a solution in which a weight concentration of the composite metal oxide support is controlled to 10 wt % or less is prepared, and, after impregnating a precursor substance of the third metal (for example, potassium hydroxide (KOH) or cerium nitrate (Ce(NO₃)₃·6H₂O)) at a concentration of 0.1 to 15 parts by weight ratio for 0.1 to 1 hour, after going through a drying process, a second heat-treatment (calcination) may be performed to form the composite metal oxide support into which the third metal is additionally introduced.

In one embodiment of the present invention, it may further comprise: a step of heat-treating the layered double hydroxide; thereafter, or, when a third metal is comprised, after the second heat-treating (calcination) step for compositing by an impregnation method of the third metal is completed, a step of reducing in the presence of a gas comprising an inert gas.

In one embodiment of the present invention, the step of reducing in the presence of the gas comprising an inert gas; may be performed at 500 to 800° C. for 0.5 to 6 hours. In addition, it is preferable for the reduction step to be performed in an H₂ gas atmosphere. The gas atmosphere of the reduction heat-treatment process is not particularly limited, and, may be performed in a pure hydrogen gas, or a mixed gas atmosphere with an inert gas such as nitrogen, argon, etc., and, preferably, may be performed under hydrogen/nitrogen mixed gas conditions of a hydrogen weight concentration of 5 to 50%.

A third aspect of the present invention provides a method for ammonia decomposition and hydrogen production, comprising: a step of preparing the metal composite catalyst for ammonia decomposition and hydrogen production according to the method; and a step of generating a separated gas comprising nitrogen and hydrogen by introducing a reaction gas comprising ammonia in the presence of the metal composite catalyst for ammonia decomposition and hydrogen production.

Regarding parts overlapping with the first aspect and the second aspect of the present invention, a detailed description thereof has been omitted, but, contents described for the first aspect and the second aspect of the present invention may be identically applied even if the description thereof is omitted in the third aspect.

Hereinafter, the method for ammonia decomposition and hydrogen production according to the third aspect of the present invention will be described in detail.

In one embodiment of the present invention, in the step of generating a separated gas comprising nitrogen and hydrogen by introducing ammonia in the presence of the metal composite catalyst for ammonia decomposition and hydrogen production, the reaction gas may comprise at least ammonia.

In one embodiment of the present invention, the step of generating a separated gas comprising nitrogen and hydrogen by introducing ammonia in the presence of the metal composite catalyst may be performed under a temperature condition of a reaction temperature of 350° C. to 700° C. If the reaction temperature is less than 350° C., the ammonia conversion rate may drop, and, if it exceeds 700° C., the stability of the catalyst may drop, or, may be inefficient. Considering the fact that, when using a conventional catalyst, an ammonia conversion rate of 80% or more is secured only when the temperature of the reaction exceeds 650° C., when utilizing the catalyst according to one embodiment of the present invention, an effect can be confirmed that a process exhibiting high activity under relatively low-temperature conditions becomes realizable.

A fourth aspect of the present invention provides a system for ammonia decomposition and hydrogen production, comprising: a reactor loaded with the catalyst; a reaction gas inlet provided at one end of the reactor, and into which ammonia is respectively injected; and a separated gas outlet provided at the other end of the reactor, and from which a gas comprising hydrogen and nitrogen separated by the ammonia decomposition reaction is discharged.

Regarding parts overlapping with the first aspect to the third aspect of the present invention, a detailed description thereof has been omitted, but, contents described for the first aspect to the third aspect of the present invention may be identically applied even if the description thereof is omitted in the fourth aspect.

Hereinafter, embodiments of the present invention will be described in detail so that a person having ordinary skill in the art to which the present invention pertains can easily carry out the same. However, the present invention may be embodied in various different forms, and is not limited by the embodiments described herein.

### Example 1: Production of Catalyst for Ammonia Decomposition and Gas Production Comprising Hydrogen

A nickel-comprising layered double hydroxide was synthesized by a coprecipitation method (Coprecipitation method). First, Solution A (first solution) in which a nickel precursor (Ni(NO₃)₂·6H₂O) and a magnesium precursor (Mg(NO₃)₂·6H₂O), and an aluminum precursor (Al(NO₃)₂·9H₂O) were added at a 1:1:1 molar concentration to 200 mL of distilled water, and Solution B (second solution) in which a carbonate precursor (Na₂CO₃) was added in half the amount of the aluminum precursor to 50 mL of distilled water, were prepared. Solution A and Solution B were simultaneously and slowly added at a constant speed to an empty beaker. At this time, a third solution (NaOH solution) was added at an appropriate speed to maintain the pH of the mixed solution at 10˜11. After the addition of the solution was completed, the mixed solution was aged while stirring at 60˜80° C. for 24 hours. After the aging was completed, the solution in a slurry state was filtered to separate the precipitate, and then was sufficiently washed with distilled water. The precipitate for which separation and washing were completed was completely dried at a high temperature of 100° C. or more to obtain the nickel-comprising layered double hydroxide. This was heat-treated at 500° C. for 3 hours to produce a layered double hydroxide-based metal oxide.

### Example 2: Production of Catalyst for Ammonia Decomposition and Gas Production Comprising Hydrogen

The composition of Solution A was produced to be nickel:magnesium:aluminum=2:1:1 molar concentration. Other than this, the synthesis process of the catalyst was produced identically to Example 1.

### Example 3: Production of Catalyst for Ammonia Decomposition and Gas Production Comprising Hydrogen

The composition of Solution A was produced to be nickel:magnesium:aluminum=3:1:1 molar concentration. Other than this, the synthesis process of the catalyst was produced identically to Example 1.

### Example 4: Production of Catalyst for Ammonia Decomposition and Gas Production Comprising Hydrogen

The composition of Solution A was produced to be nickel:magnesium:aluminum=4:1:1 molar concentration. Other than this, the synthesis process of the catalyst was produced identically to Example 1.

### Example 5: Production of Catalyst for Ammonia Decomposition and Gas Production Comprising Hydrogen

After producing (0˜10 wt %) potassium on the synthesized Example 3 metal oxide by the impregnation method (Impregnation), it was completely dried at a high temperature of 100° C. or more to obtain a potassium-comprising layered double hydroxide. This was heat-treated at 500° C. for 3 hours to produce a layered double hydroxide-based metal oxide.

### Example 6: Production of Catalyst for Ammonia Decomposition and Gas Production Comprising Hydrogen

After producing (0˜10 wt %) cerium on the synthesized Example 3 metal oxide by the impregnation method (Impregnation), it was completely dried at a high temperature of 100° C. or more to obtain a cerium-comprising layered double hydroxide. This was heat-treated at 500° C. for 3 hours to produce a layered double hydroxide-based metal oxide.

### Comparative Example 1: Production of Catalyst in which Nickel is Impregnated on a General Support

After producing by adding a nickel nitrate precursor solution to a MgAl₂O₄ support by the impregnation method (Impregnation), it was calcined at 500° C.

### Comparative Example 2: Production of Catalyst in which Nickel is Impregnated on a General Support

A commercially available catalyst was prepared by purchasing. The catalyst is a commercial catalyst to which Ni, Ca, and Al are added as components.

### Experimental Example 1: Reaction Activity Test

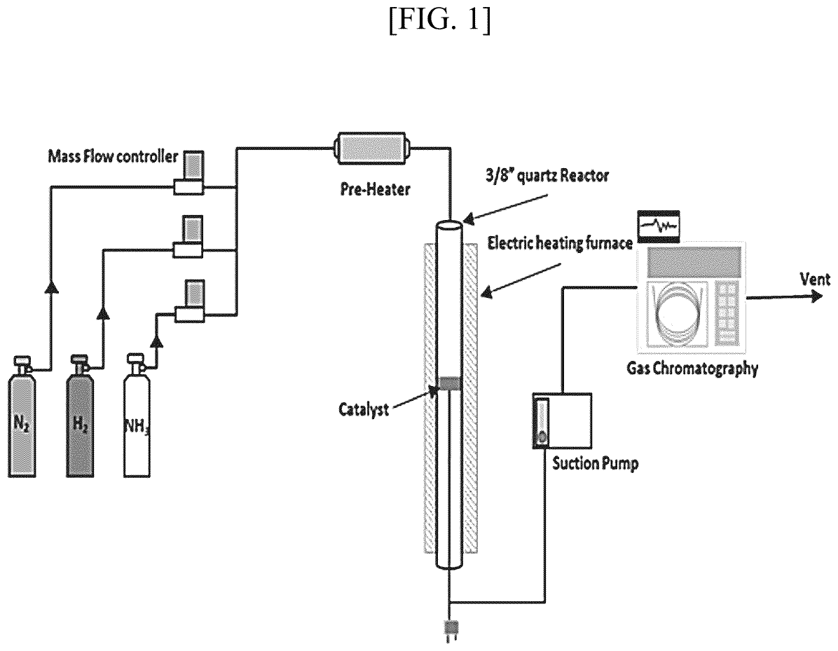

An approximate schematic diagram of the activity test is as FIG. 1. The catalyst produced for the ammonia decomposition activity experiment was prepared to 150-250 μm. Thereafter, the catalyst and a diluent were mixed and packed in the central part of a quartz reactor. The packed catalyst center temperature was confirmed through a K-type thermocouple (K-type thermocouple). The catalyst reduction was performed at 700° C. in a 20% H₂/N₂ atmosphere for 90 minutes, and, the reaction experiment was measured at a space velocity of 120,000 ml/g_{cat}·h, at 700-350° C. at 1° C./1 min intervals. 100% ammonia was used as the introduced gas, and, was analyzed using a Gas Chromatography 7890A, Agilent Technologies model. The ammonia decomposition rate and the hydrogen formation rate were calculated as below.

$$Ammonia decomposition , {X}_{NH 3} ( \% ) = \frac{FNH 3 in - FNH 3 out}{FNH 3 in} \times 100 \qquad [ Equation 1 ]$$

$$Hydrogen formation rate , {r}_{H 2} ( mmol {H}_{2} / {g}_{cat} \cdot min ) = \frac{\frac{VNH 3}{22.4} \cdot XNH 3 \cdot 1.5}{mcat} \qquad [ Equation 2 ]$$

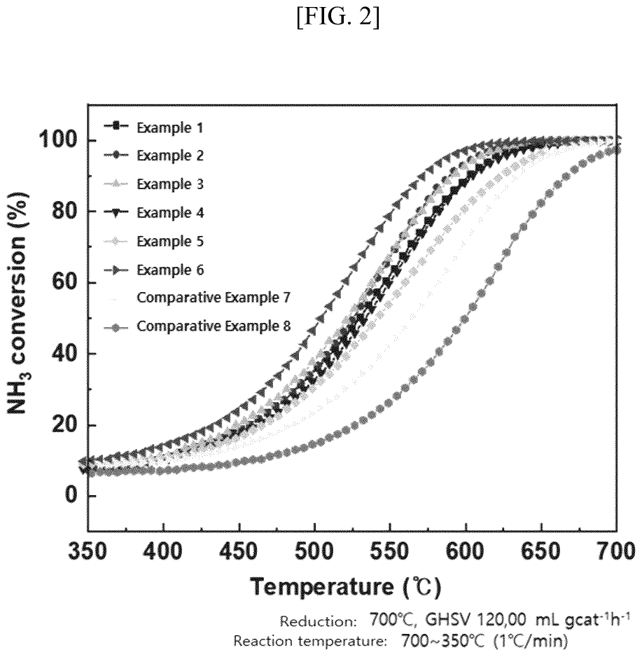

Test results for the reaction activity are as FIG. 2 and Table 1 below. FIG. 2 is experimental data comparing the ammonia decomposition catalyst activity of the catalyst according to one embodiment of the present invention by temperature.

TABLE 1

| NH₃ | | | | | | | | |
|---|---|---|---|---|---|---|---|---|
| Conversion | | | | | | | | |
| rate(%) | 700° C. | 650° C. | 600° C. | 550° C. | 500° C. | 450° C. | 400° C. | 350° C. |
| Example 1 | 99.9 | 99.0 | 90.5 | 63.9 | 36.2 | 18.8 | 10.66 | 7.4 |
| Example 2 | 100.0 | 99.5 | 92.9 | 69.3 | 36.7 | 18.8 | 10.56 | 7.3 |
| Example 3 | 100.0 | 99.6 | 93.2 | 67.8 | 38.0 | 19.8 | 11.2 | 7.6 |
| Example 4 | 99.9 | 98.5 | 90.4 | 63.1 | 34.6 | 18.2 | 10.4 | 8.0 |
| Example 5 | 99.7 | 96.4 | 80.7 | 53.8 | 30.3 | 16.2 | 10.9 | 9.1 |
| Example 6 | 100.0 | 99.9 | 97.2 | 78.6 | 46.4 | 23.7 | 13.8 | 9.8 |
| Comparative | 99.9 | 96.2 | 74.3 | 44.4 | 24.9 | 14.0 | 9.7 | 8.6 |
| Example 1 | | | | | | | | |
| Comparative | 97.5 | 85.1 | 53.2 | 28.2 | 15.3 | 9.9 | 7.4 | 6.4 |
| Example 2 | | | | | | | | |

Referring to FIG. 2 and Table 1, it could be confirmed that a difference in catalyst activity occurs according to the composition of the metal catalyst. Specifically, for Examples 1 to 3, it was confirmed that there is an increasing trend that the ammonia conversion rate rises as the nickel content becomes higher, and, in the case of Example 4 also, even in the case where the nickel content is very high, it showed an ammonia conversion rate of 90% or more at a 600° C. temperature compared to Comparative Examples 1 and 2.

In addition, comparing Examples 3, 5 and 6, it could be confirmed that a difference in catalyst activity occurs according to the added third metal component. All three samples showed a characteristic of higher low-temperature activity than the Comparative Example catalyst, and, particularly as in Example 6, when comprising cerium as the third metal, it could be confirmed that it exhibits an occurs according to the added third metal component. All ammonia conversion rate exceeding 75% even at a 550° C. temperature.

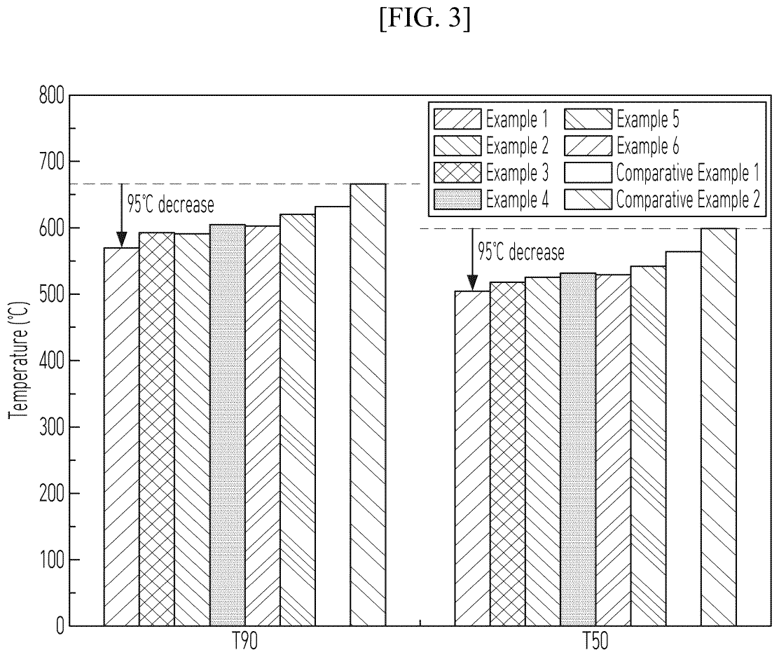

To show the results shown in the above FIG. 2 more specifically, the temperature for achieving 90% ammonia conversion rate is defined as “T90”, and the temperature for achieving 50% conversion rate is defined as “T50”, and are shown in Table 2 below and FIG. 3.

TABLE 2

| | T 90* | T 50* |
|---|---|---|
| Example 1 | 603° C. | 530° C. |
| Example 2 | 592° C. | 525° C. |
| Example 3 | 594° C. | 521° C. |
| Example 4 | 605° C. | 532° C. |
| Example 5 | 622° C. | 543° C. |
| Example 6 | 571° C. | 504° C. |
| Comparative Example 1 | 633° C. | 565° C. |
| Comparative Example 2 | 666° C. | 599° C. |

Referring to the Table 2 and FIG. 3, Examples 1 to 6 all exhibited a T90 of less than 625° C., and, exhibited a T50 range of less than 550° C. Particularly, Example 6 showed an excellent ammonia conversion rate at the lowest temperature among the catalysts as T90 (571° C.) and T50 (504° C.). On the other hand, when compared with Comparative Example 2 (nickel commercial catalyst) and Comparative Example 1 (impregnation method produced catalyst), all of the LDH-based nickel catalysts (Examples 1-6) according to one embodiment of the present invention were confirmed as having improved low-temperature reaction activity. Most significantly, compared to the Comparative Example 2 catalyst, it could be confirmed that the low-temperature activity of the Example 6 catalyst was improved by nearly 100° C.

### Experimental Example 2: Catalyst Properties Analysis

The content of the catalysts of the completed Examples 1 to 6 and Comparative Examples 1 and 2 was measured by ICP-OES, and, in the case of surface characteristics, was measured through N2 isotherm adsorption at −196° C., and, the surface area and pore volume were obtained according to the BET method, and, pore characteristics were calculated according to the BJH method. The metal particle characteristics on the surface were measured by H2-chemisorption. The measured results are as Table 3 below.

TABLE 3

| | | | | | | | Surface | | | | |
|---|---|---|---|---|---|---|---|---|---|---|---|
| | | | | | | | characteristics ² | | Metal particle | | |
| | | | | | | | Surface | Pore | characteristics ³ | | |
| | Content (wt %) ¹ | | | | | | area | volume | Dispersion | Area | Size |
| Catalyst | Ni | Mg | Al | K | Ce | Ca | (m²/g_{cat}) | (cm³/g_{cat}) | (%) | (m²/g_{cat}) | (nm) |
| Example 1 | 45.7 | 18.6 | 26.5 | — | — | — | 201.4 | 0.50 | 4.1 | 12.5 | 24.6 |
| Example 2 | 63.9 | 12.8 | 19.1 | — | — | — | 196.2 | 0.54 | 6.9 | 29.2 | 14.8 |
| Example 3 | 67.8 | 9.5 | 13.3 | — | — | — | 160.2 | 0.39 | 5.5 | 24.9 | 18.3 |
| Example 4 | 85.4 | 8.7 | 13.1 | — | — | — | 161.7 | 0.33 | 4.4 | 25.2 | 22.9 |
| Example 5 | 53.8 | 7.5 | 10.8 | 8.7 | — | — | 41.4 | 0.12 | 0.8 | 2.8 | 131.7 |
| Example 6 | 58.8 | 8.3 | 11.3 | — | 8.3 | — | 95.0 | 0.21 | 1.0 | 3.9 | 103.1 |
| Comparative | 38.3 | 24.0 | 13.6 | — | — | — | 88.1 | 0.38 | 2.6 | 6.6 | 39.0 |
| Example 1 | | | | | | | | | | | |
| Comparative | 10.3 | — | 31.8 | — | — | 7.8 | 24.6 | 0.06 | 0.4 | 0.2 | 292.2 |
| Example 2 | | | | | | | | | | | |

Referring to the Table 3, in the case of the LDH-based nickel catalyst (Examples 1˜4), it could be confirmed that even though the Ni content is much higher than Comparative Examples (1 and 2) and increases, it has higher values in BET surface area and metal dispersion. Therefore, it could be concluded that the LDH-based nickel catalyst is easy to highly disperse and uniformly support a high content of Ni active metal.

In addition, Example 6, produced by impregnating cerium to Example 3, was confirmed as showing high ammonia decomposition activity although the surface area and metal dispersion are lower than Example 3. This is a result that can be seen as that the additionally added cerium metal acts as a separate improved activity Point.

### Experimental Example 3: Reducibility Test of Catalyst

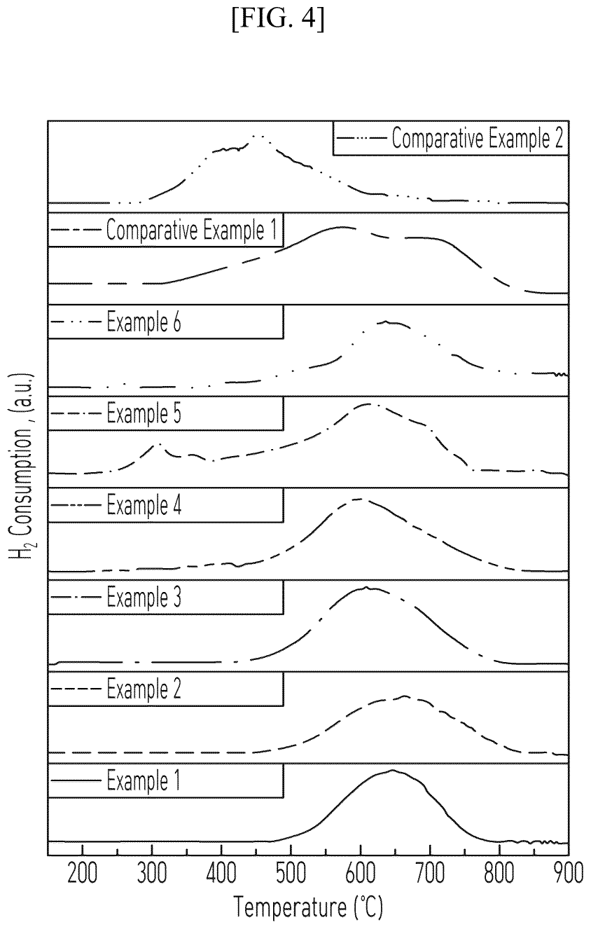

FIG. 4 is experimental data comparing the reduction temperature (H₂-TPR) for each catalyst of Examples and Comparative Examples according to one embodiment of the present invention. In addition, hydrogen consumption was measured and is shown as Table 4 below.

TABLE 4

| | hydrogen consumption |
|---|---|
| Catalyst | (H₂ Consumption, mmol/g) |
| Example 1 | 0.396 |
| Example 2 | 0.421 |
| Example 3 | 0.641 |
| Example 4 | 0.662 |
| Example 5 | 0.501 |
| Example 6 | 0.876 |
| Comparative Example 1 | 0.375 |
| Comparative Example 2 | 0.283 |

Referring to Table 4, in Examples 1 to 4, an increasing aspect could be confirmed that the hydrogen consumption increases as the Ni metal content increases. Specifically, in all of Examples 1 to 6, it could be confirmed that the hydrogen consumption exhibits a value exceeding 0.390 mmol/g and 1.0 mmol/g or less. On the other hand, Comparative Examples 1, 2 having a low Ni content exhibited a relatively small hydrogen consumption.

Referring to FIG. 4 together, the Example 6 catalyst produced by adding cerium (Ce) exhibited the most hydrogen consumption, so, it was confirmed that the reducibility was improved, and, it could be confirmed that it has a h reduction temperature due to a strong interaction between the highly dispersed and supported Ni and the support.

### Experimental Example 4: Activity Test by Space Velocity of Catalyst

To confirm whether or not the activity is maintained high, while giving a change to the space velocity, the ammonia decomposition catalyst activity was comparatively tested under the process conditions below.
Reduction condition: 700° C., 20% H₂/N₂
Space velocity (GHSV): 60,000˜360,000 mL gcat⁻¹h⁻¹ (catalyst 25 mg)
Reaction temperature: 550° C.

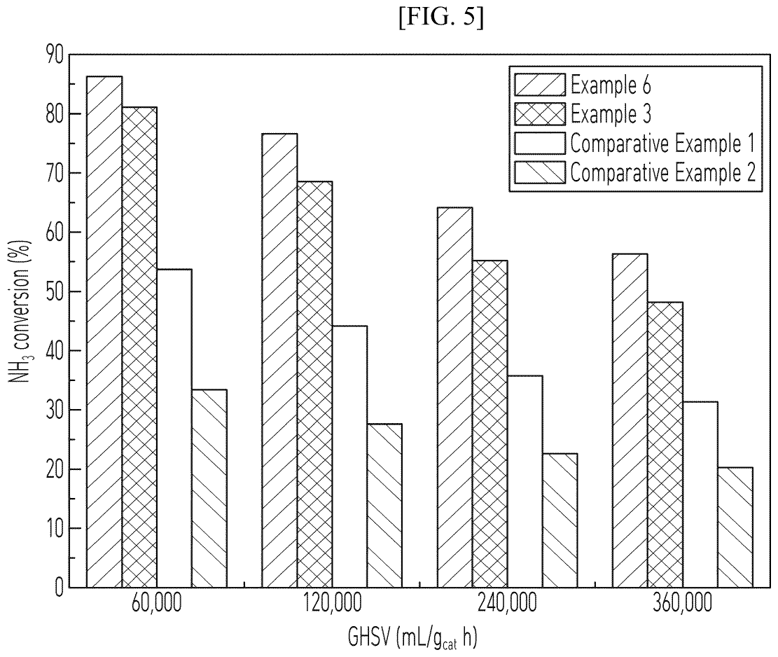

Experimental results are shown in Table 5 below and FIG. 5.

TABLE 5

| | GHSV(mL/g_{cat} h) | | | |
|---|---|---|---|---|
| | 60,000 | 120,000 | 240,000 | 360,000 |
| Example 6 | 86.2 | 76.7 | 64.1 | 56.3 |
| Example 3 | 81.1 | 68.4 | 55.2 | 48.2 |
| Comparative Example 1 | 53.8 | 44.1 | 35.6 | 31.4 |
| Comparative Example 2 | 33.2 | 27.6 | 22.6 | 20.2 |

Referring to FIG. 5 and Table 5, as a result of performing the ammonia decomposition reaction activity comparison experiment according to the space velocity change, it could be confirmed that the ammonia conversion rate decreases as the space velocity increases.

However, in the case of the catalyst of Example 3, in the entire range of the space velocity of 60,000 to 360,000 mL gcat⁻¹h⁻¹, it was confirmed that the ammonia conversion rate is all exceeding 45%, and, particularly the Example 6 catalyst to which cerium is added showed the highest ammonia conversion rate (exceeding 55%) under all space velocity conditions, and, it could be confirmed that the ammonia conversion rate is overwhelmingly higher by 20% or more than the Comparative Example catalysts.

The above-mentioned description of the present invention is for illustration, and, a person having ordinary skill in the art to which the present invention pertains will be able to understand that it can be easily modified into other specific forms without changing the technical spirit or essential characteristics of the present invention. Therefore, the embodiments described above must be understood as being illustrative in all aspects and not limiting. For example, each component described as a single type may be carried out in a distributed manner, and, likewise, components described as being distributed may also be carried out in a combined form.

The scope of the present invention is indicated by the claims to be described later, and, all changes or modified forms derived from the meaning and scope of the claims and their equivalent concepts should be interpreted as being included in the scope of the present invention.

What is claimed is:

1. A metal composite catalyst for ammonia decomposition and hydrogen production, comprising:
a composite metal oxide support;
and metal nanoparticles dispersed on a surface or the inside of pores of the composite metal oxide; wherein the composite metal oxide support is derived from a layered double hydroxide comprising nickel and at least two types of metals different from nickel,
the metal nanoparticles are reduced from the composite metal oxide support,
and the weight content of nickel metal, measured by ICP analysis, is 45 wt % or more.

2. The metal composite catalyst for ammonia decomposition and hydrogen production according to claim 1, wherein the metal composite catalyst comprises magnesium as a first metal and aluminum as a second metal, and based on 100 parts by weight of the metal composite catalyst, a content of the first metal is 5 to 20 parts by weight, and a content of the second metal is 5 to 30 parts by weight.

3. The metal composite catalyst for ammonia decomposition and hydrogen production according to claim 1, further comprising a third metal introduced by an impregnation method, wherein the third metal comprises potassium or cerium.

4. The metal composite catalyst for ammonia decomposition and hydrogen production according to claim 3, wherein based on 100 parts by weight of the metal composite catalyst, the content of the third metal is 5 to 10 parts by weight.

5. The metal composite catalyst for ammonia decomposition and hydrogen production according to claim 1, wherein a metal dispersion (Metal Dispersion) of the metal nanoparticles of the metal composite catalyst for ammonia decomposition and hydrogen production is 0.5 to 8%.

6. The metal composite catalyst for ammonia decomposition and hydrogen production according to claim 1, wherein a dispersed area of the metal nanoparticles of the metal composite catalyst for ammonia decomposition and hydrogen production is 2 to 35 m2/gcat.

7. The metal composite catalyst for ammonia decomposition and hydrogen production according to claim 1, wherein a BET surface area of the metal composite catalyst for ammonia decomposition and hydrogen production is 90 to 250 m2/g.

8. The metal composite catalyst for ammonia decomposition and hydrogen production according to claim 1, wherein a total pore volume of the metal composite catalyst for ammonia decomposition and hydrogen production is 0.10 to 0.7 cm3/g.

9. The metal composite catalyst for ammonia decomposition and hydrogen production according to claim 1, wherein a dispersion of the metal nanoparticles per particle area of the metal (m2) is 0.35% or less.

10. A method for manufacturing a metal composite catalyst for ammonia decomposition and hydrogen production, comprising: a step of preparing a first solution by preparing a nickel precursor and precursors of at least two types of different metals respectively and mixing them; a step of preparing a second solution comprising a carbonate precursor; a step of obtaining a first mixture by simultaneously adding a third solution upon mixing the first and second solutions; a step of aging the first mixture; a step of separating a precipitate of the aged first mixture; wherein a weight content of nickel metal, measured by ICP analysis, is 45 wt % or more.

11. The method for manufacturing a metal composite catalyst for ammonia decomposition and hydrogen production according to claim 10, further comprising: a step of heat-treating the layered double hydroxide; thereafter a step of introducing a third metal by adding a precursor solution of the third metal and impregnating the same onto the heat-treated layered double hydroxide; and a step of secondarily heat-treating the layered double hydroxide-based metal oxide support into which the third metal has been introduced.

12. The method for manufacturing a metal composite catalyst for ammonia decomposition and hydrogen production according to claim 10, further comprising: a step of heat-treating the layered double hydroxide; thereafter a step of reducing in the presence of a gas containing an inert gas.

13. The method for manufacturing a metal composite catalyst for ammonia decomposition and hydrogen production according to claim 10, wherein in the step of preparing the first solution; a ratio of the moles of nickel to the sum of moles of at least two types of metals is 0.3 to 3:1.

14. The method for manufacturing a metal composite catalyst for ammonia decomposition and hydrogen production according to claim 10, wherein in the step of preparing the second solution; a pH of the second solution after addition of a base is 8 to 11, the step of aging the second mixture; is to stir at a temperature of 40 to 80° C. for 6 to 48 hours, and the step of heat-treating the layered double hydroxide or the second heat-treating step; is performed at 400 to 800° C. for 1 to 6 hours.

15. A method for ammonia decomposition and hydrogen production, comprising: a step of preparing the metal composite catalyst for ammonia decomposition and hydrogen production according to claim 10; and a step of generating a separated gas comprising nitrogen and hydrogen by introducing a reaction gas containing ammonia in the presence of the metal composite catalyst for ammonia decomposition and hydrogen production.
